(19) United States
(12) Patent Application Publication
(10) Pub. No.: US 2018/0022147 A1
(43) Pub. Date: Jan. 25, 2018

(54) CARBON FIBER SPOKE

(71) Applicant: FOSS WORLDWIDE INC., Taichung City (TW)

(72) Inventor: Tseng-Ping TIEN, Taichung City (TW)

(73) Assignee: FOSS WORLDWIDE INC., Taichung City (TW)

(21) Appl. No.: 15/654,154

(22) Filed: Jul. 19, 2017

(30) Foreign Application Priority Data
Jul. 25, 2016 (TW) 105123410

(51) Int. Cl. B60B 1/02; B60B 5/02; B60B 1/00

(52) U.S. Cl. CPC B60B 1/0261; B60B 1/006; B60B 5/02; B60B 1/0253; B60B 1/003; B60B 2360/3416; B60B 2900/111; B60B 2900/311; B60B 2900/513

(57) ABSTRACT

A carbon fiber spoke includes a carbon fiber stick having two opposite ends, wherein a first joint and a second joint are respectively mounted to the two opposite ends of the carbon fiber stick. The first joint and the second joint respectively includes a through hole longitudinally and centrally defined therein for allowing the carbon fiber stick extending therethrough. The two opposite ends of the carbon fiber stick are respectively formed with an enlarged portion and each through hole formed with an enlarged portion, wherein each enlarged portion is complementally received in the enlarged portion in the first joint/second joint to prevent the first joint and the second joint from being detached from the carbon fiber stick.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a spoke, and more particularly to a carbon fiber spoke.

### 2. Description of Related Art Including Information Disclosed Under 37 CFR 1.97 and 37 CFR 1.98

A conventional spoke in accordance with the prior art is usually made of metal such the conventional spoke is heavy. For the lightweight spoke for a bicycle, some manufacturers make the spoke with carbon fiber spoke for providing the advantages of high hardness, high strength, light weight, anti-high-temperature and low coefficient of expansion.

The conventional carbon fiber spoke includes a carbon fiber stick having two opposite ends each having a joint mounted thereto by adhesive. In manufacturing the conventional carbon fiber spoke, the end of the carbon fiber stick is inserted into the joint and positioned by adhesive. However, the carbon fiber stick may be detached from the joint when the adhesive is used for a period of time and goes bad. As a result, the connection between the carbon fiber stick and the joint is weakened. As well known, the carbon fiber spoke is more expensive than metal spoke. It is a serious problem to the consumer before the above disadvantage of the conventional carbon fiber spoke being overcome.

The present invention has arisen to mitigate and/or obviate the disadvantages of the conventional spokes.

### BRIEF SUMMARY OF THE INVENTION

The main objective of the present invention is to provide an improved carbon fiber spoke that has a strengthened connection.

To achieve the objective, the carbon fiber spoke in accordance with the present invention comprises a carbon fiber stick having two opposite ends, wherein a first joint and a second joint are respectively mounted to the two opposite ends of the carbon fiber stick. The first joint and the second joint respectively includes a through hole longitudinally and centrally defined therein for allowing the carbon fiber stick extending therethrough. The two opposite ends of the carbon fiber stick are respectively formed with an enlarged section and each through hole formed with an enlarged portion, wherein each enlarged section is complementally received in the enlarged portion in the first joint/second joint to prevent the first joint and the second joint from being detached from the carbon fiber stick.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of a carbon fiber spoke in accordance with the present invention.

FIG. 2 is a cross-sectional view of the carbon fiber spoke in FIG. 1.

FIG. 3 is a partially exploded perspective view of the carbon fiber spoke in FIG. 1.

FIG. 4 is a partially exploded view in cross-section of the carbon fiber spoke in FIG. 1.

FIG. 5 is a partially enlarged view of FIG. 2.

FIG. 6 is a partially cross-sectional view of a second preferred embodiment of the carbon fiber spoke in accordance with the present invention.

FIG. 7 is a partially cross-sectional view of a third preferred embodiment of the carbon fiber spoke in accordance with the present invention.

FIG. 8 is a partially cross-sectional view of a fourth preferred embodiment of the carbon fiber spoke in accordance with the present invention.

FIG. 9 is a partially cross-sectional view of a fifth preferred embodiment of the carbon fiber spoke in accordance with the present invention.

FIG. 10 is a partially cross-sectional view of a sixth preferred embodiment of the carbon fiber spoke in accordance with the present invention.

FIG. 11 is a partially cross-sectional view of a seventh preferred embodiment of the carbon fiber spoke in accordance with the present invention.

FIG. 12 is a partially cross-sectional view of an eighth preferred embodiment of the carbon fiber spoke in accordance with the present invention.

FIG. 13 is a partially cross-sectional view of a ninth preferred embodiment of the carbon fiber spoke in accordance with the present invention;

FIG. 14 is a side schematic view of the carbon fiber spoke in accordance with the present invention.

FIG. 15 illustrates a rim having the carbon fiber spoke of the present invention.

### DETAILED DESCRIPTION OF THE INVENTION

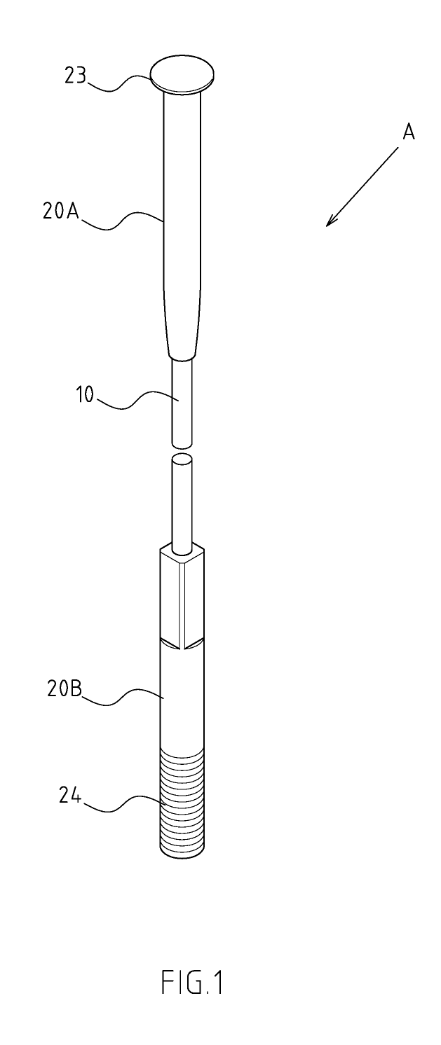

Referring to the drawings and initially to FIGS. 1-5, a carbon fiber spoke A in accordance with the present invention comprises a carbon fiber stick 10 having two opposite ends, wherein a first joint 20A and a second joint 20B are respectively mounted to the two opposite ends of the carbon fiber stick 10. The first joint 20A and the second joint 20B respectively includes a through hole 21 longitudinally and centrally defined therein for allowing the carbon fiber stick 10 extending therethrough. The two opposite ends of the carbon fiber stick 10 are respectively formed with an enlarged section 11 and each through hole 21 formed with an enlarged portion 22, wherein each enlarged section 11 is complementally received in the enlarged portion 22 in the first joint 20A/second joint 20B to prevent the first joint 20A and the second joint 20B from being detached from the carbon fiber stick 10.

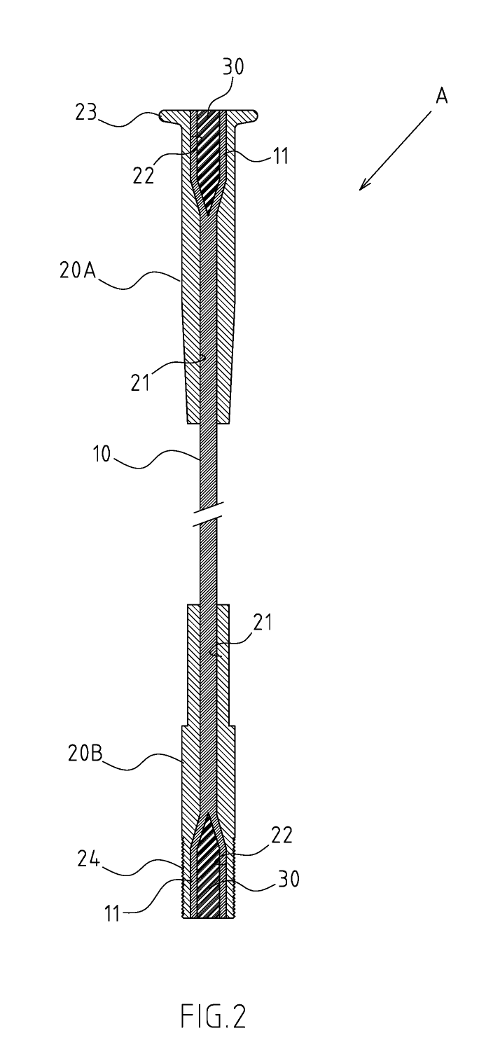

With reference to FIGS. 1 and 2, the first joint A includes a stopper 23 formed on a distal end thereof and the second joint B includes an outer threaded section 24 formed on a distal end thereof.

With reference to FIG. 6, a carbon fiber layer (not numbered) is secured on each end of the carbon fiber stick 10 to form the enlarged section 11B thereon.

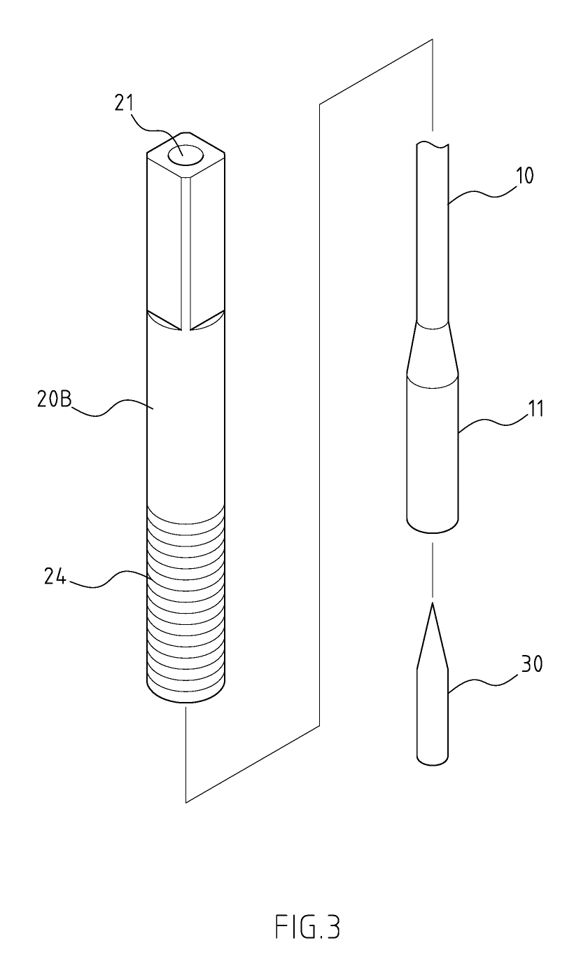

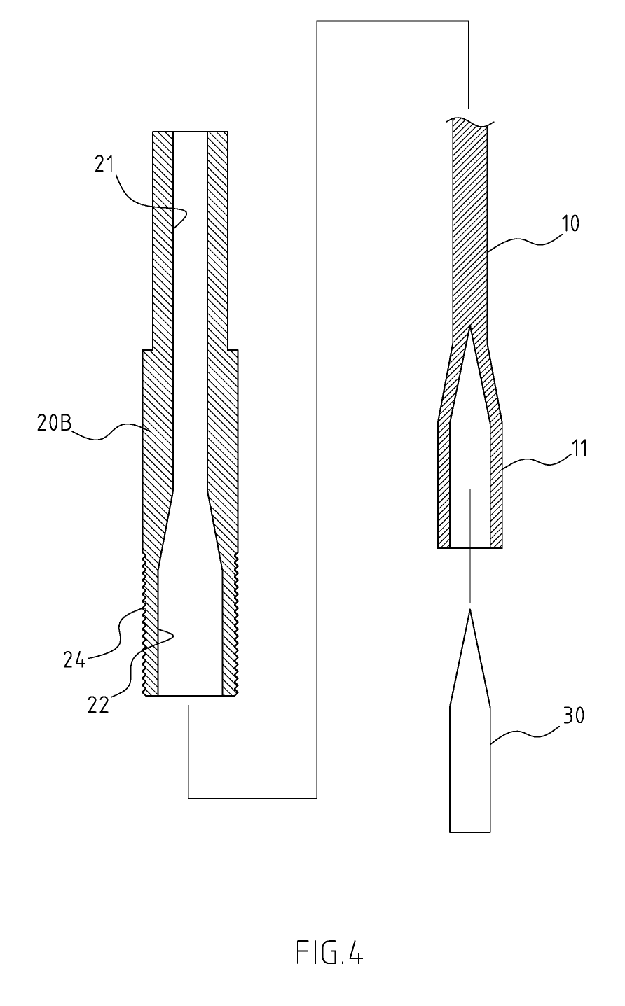

With reference to FIGS. 3 and 4, each enlarged section 11 of the carbon fiber stick 10 is hollow.

With reference to FIG. 12, the carbon fiber stick 10 is provided to assemble a hub 41 and a rim 42. The carbon fiber stick 10 has two opposite ends each formed with an enlarged section 11, and the through hole 21 in each of the first joint 20A and the second joint 20B formed with an enlarged portion 22, wherein each enlarged section 11 is complementally received in the enlarged portion 22 in the first joint 20A/second joint 20B to provide an engaging-type anti-detaching effect. As a result, the connection between the carbon fiber stick 10 and the first joint 20A/second joint 20B becomes more stable and has a long use life relative to the conventional carbon fiber spoke that is secured by adhesive.

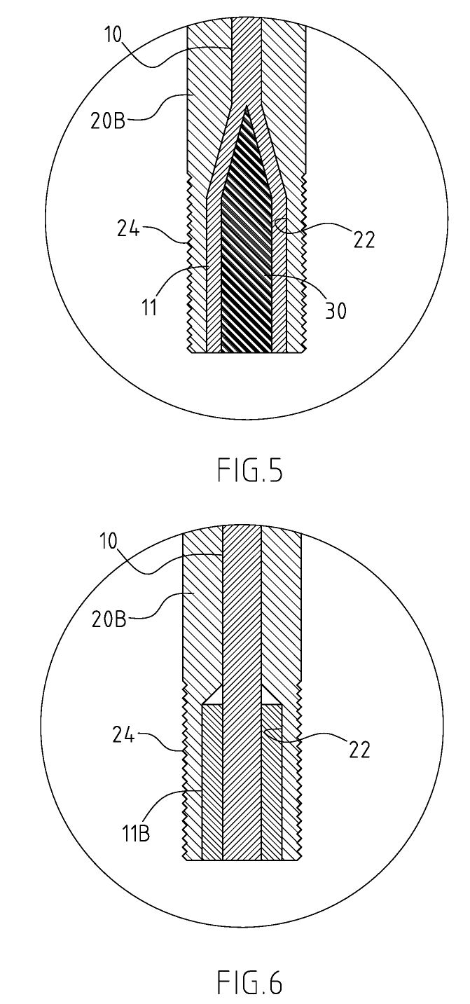

With reference to FIG. 5, each enlarged section 11 of the carbon fiber stick 10 has a plug 30 inserted thereinto for supporting the enlarged section 11.

The plug 30 is formed by a material selected from a group consisted of aluminum, plastic and solid material. As a result, the enlarged section 11 of the carbon fiber stick is also formed when inserting the plug 30 and the plug 30 can be removed from the carbon fiber stick 10 after forming the enlarged section 11. In addition, the plug 30 also can be a water bottle.

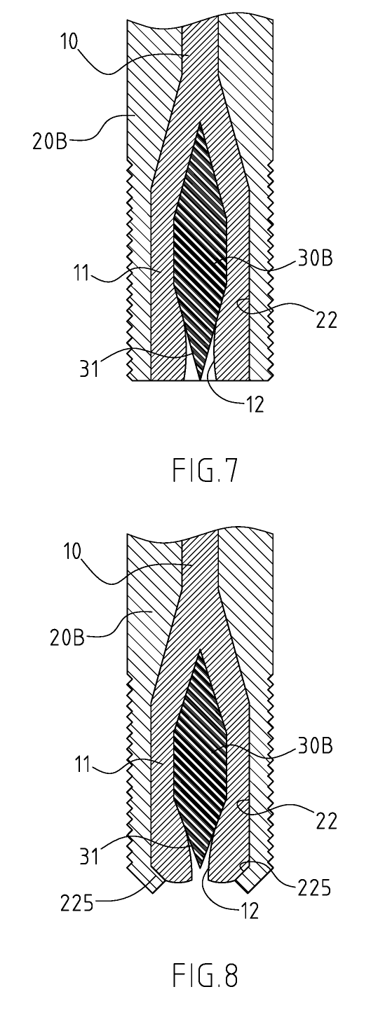

With reference to FIG. 7, in this preferred embodiment of the present invention, each plug 30B is formed with a tapered portion 31 and each end of the carbon fiber stick 10 is formed with a narrowed portion 12 coupled with the tapered portion 31 of a corresponding one of the two plugs 30B.

With reference to FIG. 8, in this preferred embodiment of the present invention, each of the first joint 20A and second joint 20B has a flange 225 inwardly extending from a distal end thereof and coupled with a distal end of a corresponding one of the two enlarged section 11 of the carbon fiber stick 10 for preventing the carbon fiber stick 10 extending through the first joint 20A/the second joint 20B. In this preferred embodiment, the plug 30B is bullet-shaped.

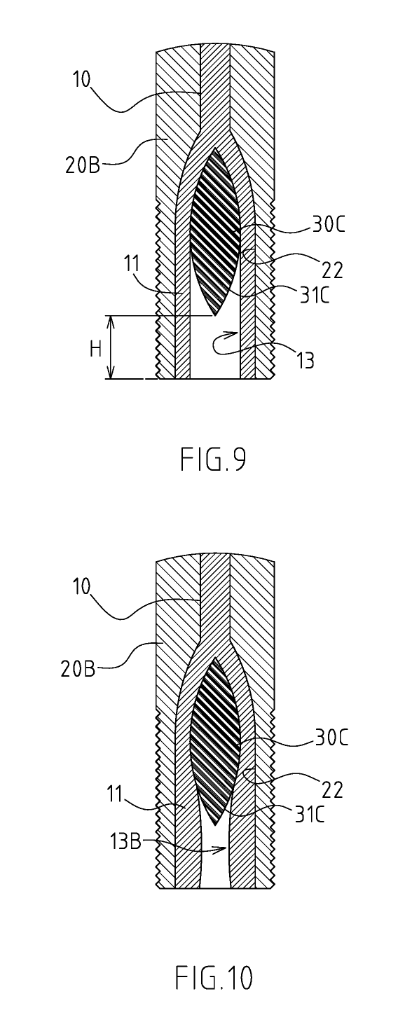

With reference to FIG. 9, in this preferred embodiment of the present invention, each plug 30C is formed with a tapered portion 31C, wherein a distance H is formed between a distal end of the carbon fiber stick 10 and a free end of the tapered portion 31C. An anti-detaching portion 13 is formed on an inner periphery of each enlarged section 11 of the carbon fiber stick 10, wherein the anti-detaching portion 13 has a straight cross-section. With reference to FIG. 10, the anti-detaching portion 13B has a curved cross-section. The anti-detaching portion 13/13B is provided to effectively prevent the plug 30C from detaching from the carbon fiber stick 10. A relative longitudinal tension/pressure is caused between the carbon fiber stick 10 and the first joint 20A/second joint 20B during assembling the carbon fiber spoke A in accordance with the present invention. The inserted plug 30C prevents the enlarged section 11 of the carbon fiber stick 10 from being moved relative the first joint 20A/second joint 20B. In addition, the anti-detaching portion 13/13B prevents the plug 30C from detaching from the enlarged section 11 of the carbon fiber stick 10.

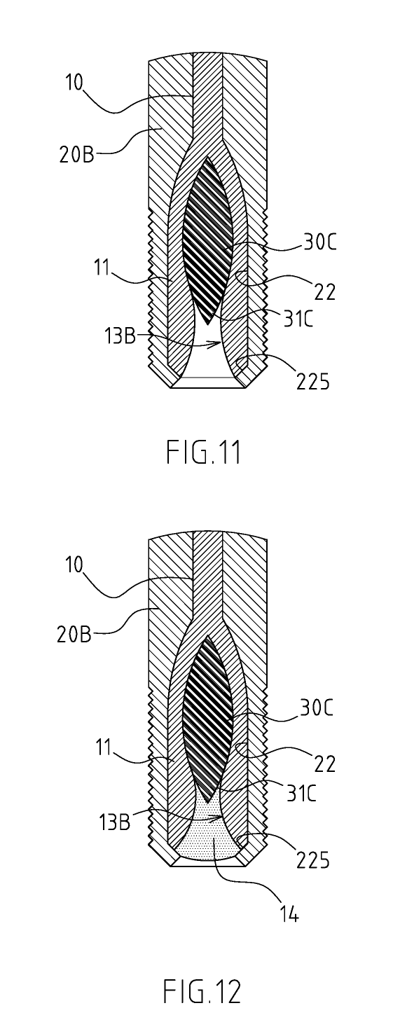

With reference to FIG. 11, in this preferred embodiment of the present invention, each of the first joint 20A and second joint 20B has a flange 225 inwardly extending from a distal end thereof and coupled with a distal end of a corresponding one of the two enlarged section 11 of the carbon fiber stick 10 for preventing the carbon fiber stick 10 extending through the first joint 20A/the second joint 20B. In this preferred embodiment, the flange 225 is formed by rolling process and integrally extends from the first joint 20A/second joint 20B such that the flange 225 effectively prevents the enlarged section 11 from detaching from the first joint 20A/second joints 20B.

With reference to FIG. 12, in this preferred embodiment of the present invention, curing material 14 is filled the enlarged section 11 and corresponds to the anti-detaching portion 13B such that the total anti-detaching effect of the carbon fiber spoke A in accordance with the present invention is promoted.

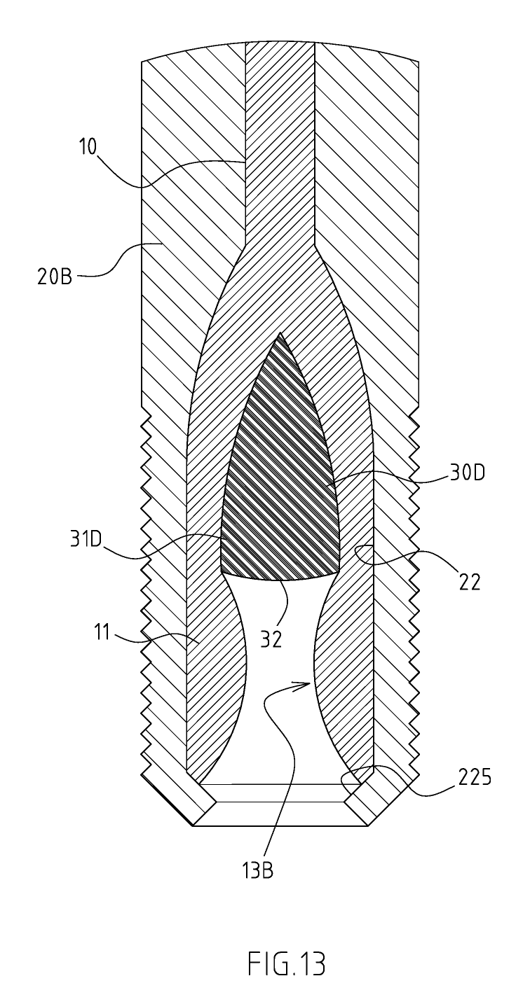

With reference to FIG. 13, in this preferred embodiment of the present invention, the plug 30D is formed with a blunt face 32 where the plug 30D has a greatest cross-section. The blunt face 32 is curved or plan. A distance is formed between a distal end of the carbon fiber stick 10 and the blunt face 32 of the plug 30D. An anti-detaching portion 13B is formed on an inner periphery of each enlarged section 11 of the carbon fiber stick 10, wherein the anti-detaching portion 13B is curved. The carbon fiber stick 10 is previously heated before inserting the plug 30D in to a corresponding one of the two enlarged section 11 of the carbon fiber stick 10. Consequently, the blunt face 32 prevents the 30D from detaching from the carbon fiber stick 10 when the carbon fiber stick is cooled and hardened.

The anti-detaching portion 13B, as shown in FIGS. 7-8 and 10-13, is integrally formed with the carbon fiber stick 10 is heated and softened when inserting the plug 30B/30C/30D.

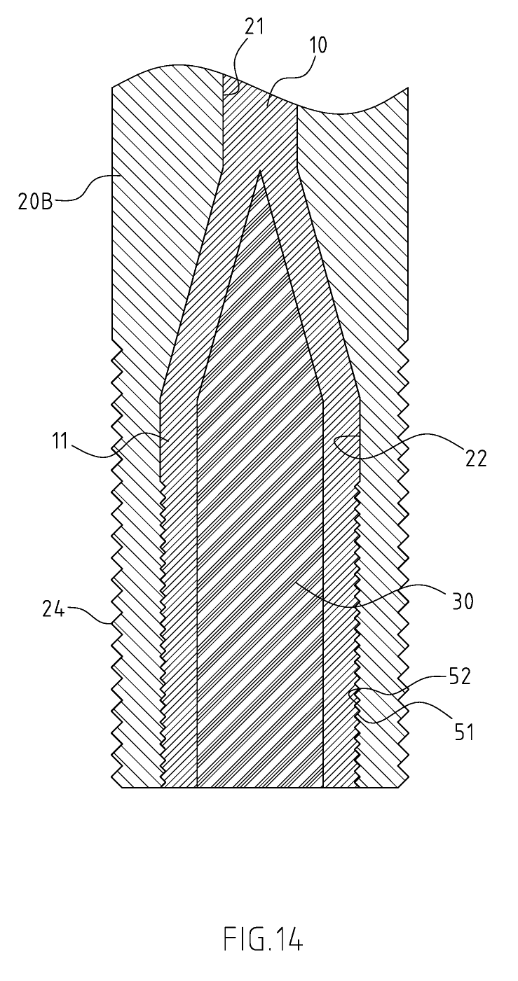

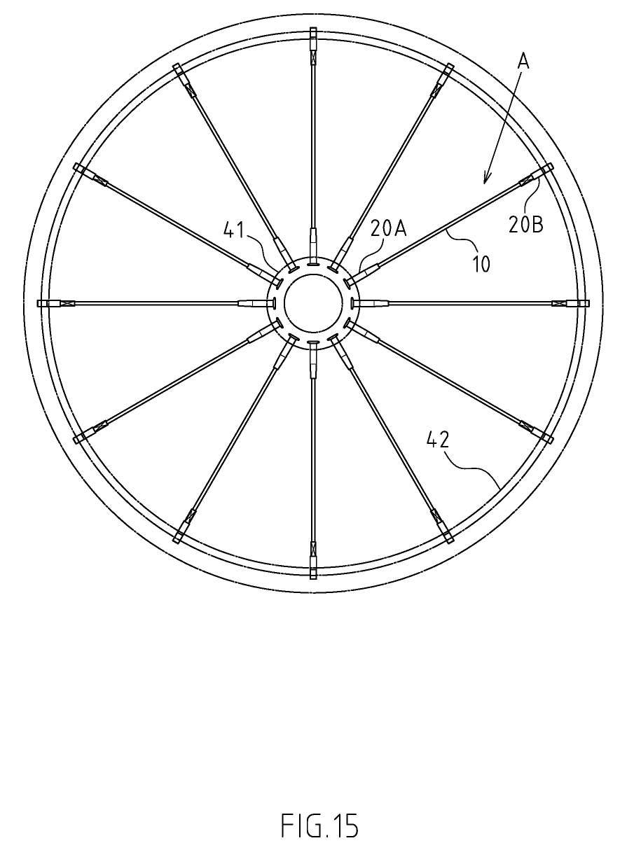

With reference to FIG. 14, each enlarged section 11 of the carbon fiber stick 10 has a series of grooves 51 defined in an outer periphery thereof and the enlarged portion 22 of the first joint 20A/second joint 20B has a series of ribs 52 formed in an inner periphery thereof, wherein each ribs 52 is complementally received in a corresponding one of the series of grooves 51 for strengthening the connection between the carbon fiber stick 10 and the first joint 20A/second joint 20B.

Although the invention has been explained in relation to its preferred embodiment, it is to be understood that many other possible modifications and variations can be made without departing from the spirit and scope of the invention as hereinafter claimed.

I claim:

1. A carbon fiber spoke comprising a carbon fiber stick having two opposite ends, wherein a first joint and a second joint are respectively mounted to the two opposite ends of the carbon fiber stick, the first joint and the second joint respectively including a through hole longitudinally and centrally defined therein for allowing the carbon fiber stick extending therethrough, the two opposite ends of the carbon fiber stick respectively formed with an enlarged section and each through hole formed with an enlarged portion, wherein each enlarged section is complementally received in the enlarged portion in the first joint/second joint to prevent the first joint and the second joint from being detached from the carbon fiber stick.

2. The carbon fiber spoke as claimed in claim 1, wherein each enlarged section of the carbon fiber stick is hollow.

3. A carbon fiber spoke comprising a carbon fiber stick having two opposite ends, wherein a first joint and a second joint are respectively mounted to the two opposite ends of the carbon fiber stick, the first joint and the second joint respectively including a through hole longitudinally and centrally defined therein for allowing the carbon fiber stick extending therethrough, the two opposite ends of the carbon fiber stick respectively formed with an enlarged section and each through hole formed with an enlarged portion, wherein each enlarged section is complementally received in the enlarged portion in the first joint/second joint to prevent the first joint and the second joint from being detached from the carbon fiber stick, wherein each enlarged section of the carbon fiber stick has a plug inserted thereinto for supporting the enlarged section.

4. The carbon fiber spoke as claimed in claim 3, wherein each plug is formed with a tapered portion and each end of the carbon fiber stick is formed with a narrowed portion coupled with the tapered portion of a corresponding one of the two plugs.

5. The carbon fiber spoke as claimed in claim 4, wherein each of the first joint and second joint has a flange inwardly extending from a distal end thereof and coupled with a distal end of a corresponding one of the two enlarged section of the carbon fiber stick for preventing the carbon fiber stick extending through the first joint/the second joint.

6. The carbon fiber spoke as claimed in claim 3, wherein each plug is formed with a tapered portion and a distance is formed between a distal end of the carbon fiber stick and a free end of the tapered portion, an anti-detaching portion formed on an inner periphery of each enlarged section of the carbon fiber stick.

7. The carbon fiber spoke as claimed in claim 6, wherein each of the first joint and second joint has a flange inwardly extending from a distal end thereof and coupled with a distal end of a corresponding one of the two enlarged section of the carbon fiber stick for preventing the carbon fiber stick extending through the first joint/the second joint.

8. The carbon fiber spoke as claimed in claim 5, wherein curing material is filled the enlarged section and corresponds to the anti-detaching portion.

9. The carbon fiber spoke as claimed in claim 7, wherein curing material is filled the enlarged section and corresponds to the anti-detaching portion.

10. The carbon fiber spoke as claimed in claim 3, wherein the plug is formed with a blunt face where the plug has a greatest cross-section and a distance is formed between a distal end of the carbon fiber stick and the blunt face of the plug, an anti-detaching portion is formed on an inner periphery of each enlarged section of the carbon fiber stick.

11. The carbon fiber spoke as claimed in claim 3, wherein each enlarged section of the carbon fiber stick has a series of grooves defined in an outer periphery thereof and the enlarged portion of the first joint second joint has a series of ribs formed in an inner periphery thereof, and wherein each ribs is complementally received in a corresponding one of the series of grooves.
